(19) United States
(12) Patent Application Publication
(10) Pub. No.: US 2019/0164456 A1
(43) Pub. Date: May 30, 2019

(54) METHOD FOR CONTROLLING DISPLAY, SYSTEM FOR CONTROLLING DISPLAY, AND DISPLAY APPARATUS

(71) Applicant: SHENZHEN ROYOLE TECHNOLOGIES CO. LTD., Shenzhen, Guangdong (CN)

(72) Inventor: Zegang YE, Shenzhen, Guangdong (CN)

(21) Appl. No.: 16/314,518

(22) PCT Filed: Nov. 4, 2016
(86) PCT No.: PCT/CN2016/104715

§ 371 Date: Dec. 31, 2018

(51) Int. Cl. G09F 9/30; G06F 1/16; G06F 3/14

(52) U.S. Cl. CPC G09F 9/301; G09G 2380/02; G06F 3/14; G06F 1/1652

(57) ABSTRACT

Disclosed are a method for controlling display, and a display apparatus. The display apparatus may include a flexible display screen. The method may include the follows. A bending degree of the flexible display screen is determined when a user interface is displayed on the flexible display screen. A deformation value of the user interface is determined according to the bending degree and a preset correspondence relationship. The preset correspondence relationship is a correspondence relationship between the bending degrees of the flexible display screen and the deformation values of the user interface. The user interface is adjusted according to the deformation value. The adjusted user interface is displayed on the flexible display screen.

### TECHNICAL FIELD

The present disclosure relates to the technical field of display, and particularly to a method for controlling display, a system for controlling display, and a display apparatus.

### BACKGROUND

With the development of a flexible display screen, more and more display apparatuses, such as head-mounted displays, televisions, tablet computers and the like, employ the flexible display screen. However, presently, the flexible display screen installed in the display apparatus is just used for display, and a manner in which the flexible display screen displays contents is fixed, thereby causing the manner in which the flexible display screen displays contents to be simple.

### SUMMARY

In view of the above, embodiments of the present disclosure provide a method for controlling display, a system for controlling display, and a display apparatus, so as to solve a problem that a manner in which the a flexible display screen displays contents is simple.

The embodiments of the present disclosure provide a method for controlling display. The method is applied in a display apparatus. The display apparatus may include a flexible display screen. The method for controlling display may include the follows. A bending degree of the flexible display screen is determined when a user interface is displayed on the flexible display screen. A deformation value of the user interface is determined according to the bending degree of the flexible display screen and a preset correspondence relationship, wherein the preset correspondence relationship is a correspondence relationship between the bending degrees of the flexible display screen and the deformation values of the user interface. The user interface is adjusted according to the determined deformation value. The adjusted user interface is displayed on the flexible display screen.

The embodiments of the present disclosure further provide a system for controlling display. The system is applied in a display apparatus. The display apparatus may include a flexible display screen. The system for controlling display may include a bending degree determining module configured to determine a bending degree of the flexible display screen when the display apparatus displays a user interface on the flexible display screen, and a deformation value determining module configured to determine a deformation value of the user interface according to the bending degree of the flexible display screen and a preset correspondence relationship, wherein the preset correspondence relationship is a correspondence relationship between the bending degrees of the flexible display screen and the deformation values of the user interface. The system may further include an adjusting module, configured to adjust the user interface according to the determined deformation value, and a displaying module configured to display the adjusted user interface on the flexible display screen.

The embodiments of the present disclosure further provide a display apparatus. The display apparatus may include a flexible display screen, a memory storing a set of program codes, and a processor configured to invoke the program codes to perform the follows. A bending degree of the flexible display screen is determined when a user interface is displayed on the flexible display screen. A deformation value of the user interface is determined according to the bending degree of the flexible display screen and a preset correspondence relationship, wherein the preset correspondence relationship is a correspondence relationship between the bending degrees of the flexible display screen and the deformation values of the user interface. The user interface is adjusted according to the determined deformation value. The adjusted user interface is displayed on the flexible display screen.

In the embodiments of the present disclosure, the shape of the user interface is changed according to the bending degree of the flexible display screen, thus the display effect of the user interface displayed on the flexible display screen is improved, and user experience is improved.

### BRIEF DESCRIPTION OF THE DRAWINGS

In order to illustrate technical solutions in embodiments of the present disclosure more clearly, the following briefly introduces the accompanying drawings required for describing the embodiments. Apparently, the accompanying drawings in the following description illustrate some embodiments of the present disclosure. Those of ordinary skill in the art may also obtain other drawings based on these accompanying drawings without creative efforts.

FIG. 1 is a flow chart illustrating a method for controlling display according to an embodiment of the present disclosure.

FIG. 2 is a schematic structural view illustrating a flexible display screen without being bent according to an embodiment of the present disclosure, illustrating distance sensors being arranged in a left side, middle, and right side of the flexible display screen, respectively.

FIG. 3 is a schematic structural view illustrating the flexible display screen after being bent according to an embodiment of the present disclosure, and illustrating a manner in which an angle β representing a bending degree is determined.

FIG. 4 is a schematic structural view illustrating a user interface according to an embodiment of the present disclosure, and illustrating an included angle α representing a deformation degree of the user interface.

FIG. 5 illustrates a manner in which the included angle α in FIG. 4 is determined.

FIG. 6 is a schematic structural diagram illustrating a system for controlling display according to an embodiment of the present disclosure.

FIG. 7 is a schematic structural diagram illustrating a display apparatus according to an embodiment of the present disclosure.

### DETAILED DESCRIPTION

Below technical solutions of embodiments of the present disclosure will be described clearly and completely in conjunction with the accompanying drawings of the embodiments of the present disclosure. Apparently, some but not all of embodiments of the present disclosure are described. Based on the embodiments of the present disclosure, all the other embodiments, which a person ordinarily skilled in the art obtains without paying creative efforts, fall within the scope of protection of the present disclosure.

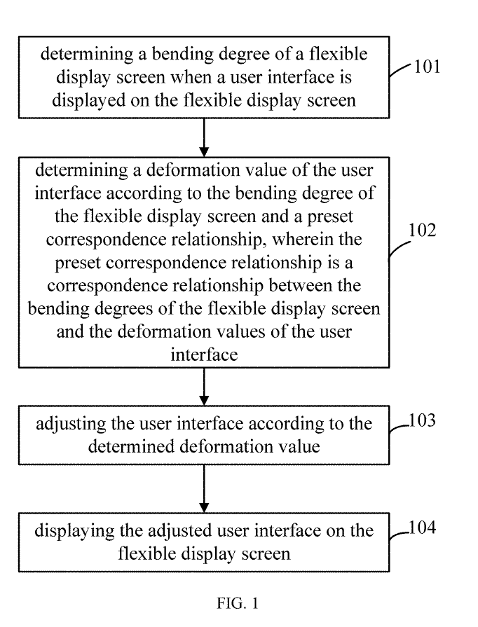

Referring to FIG. 1, FIG. 1 is a schematic flow chart illustrating a method for controlling display according to an embodiment of the present disclosure. The method for controlling display is applied in a display apparatus having a flexible display screen. The display apparatus may be an integrated display apparatus, and also may be a separate display apparatus, that is, the flexible display screen is separately arranged. When the display apparatus is the integrated display apparatus, the whole display apparatus can be deformed. When the flexible display screen is separately arranged, the flexible display screen can be deformed individually. The display apparatus may be a display apparatus having an image or text display function such as a smart phone, a tablet computer, a head-mounted display, a television, and the like. The method for controlling display may include the follows.

Step 101, a bending degree of the flexible display screen is determined when a user interface is displayed on the flexible display screen.

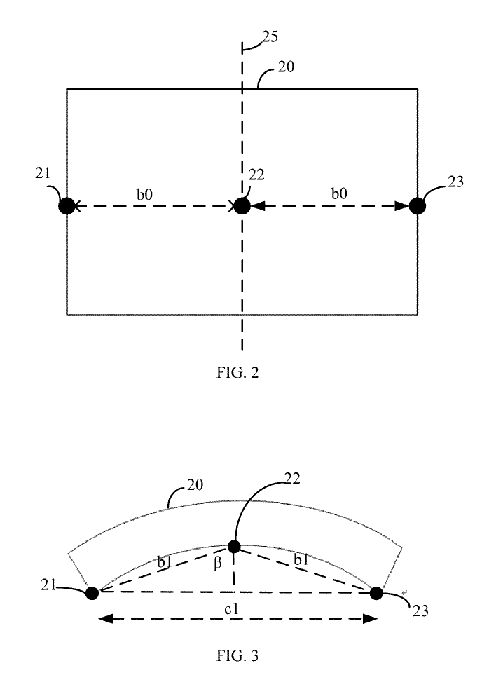

As illustrated in FIG. 2, distance sensors 21, 22, and 23 are arranged on a left side, a middle, and a right side of the flexible display screen 20, respectively. The distance sensors 21, 22, and 23 may be laser sensors, ultrasonic sensors, and the like. When the flexible display screen 20 is not bent, the distance sensors 21, 22, and 23 are collinear in a horizontal line. A distance between the distance sensor 22 and the distance sensor 21 is equal to that between the distance sensor 22 and the distance sensor 23, and both of which are b0. Referring to FIG. 3, FIG. 3 is a top view illustrating the flexible display screen 20 when the left side and the right side of the flexible display screen 20 are bent inwardly along the middle of the flexible display screen 20. As illustrated in FIG. 3, the distance between the distance sensor 22 and the distance sensor 21 and the distance between the distance sensor 22 and the distance sensor 23 are changed to b1, the distance sensors 21, 22, and 23 are not in line, and the distance sensors 21 and 23 are in line. The distance between the distance sensor 21 and the distance sensor 23 is c1. According to the distances b1 and c1, an included angle β between a central line passing through the distance sensor 22 and a connection line connecting the distance sensors 21 and 22 can be determined. The included angle β is defined as a bending degree of the flexible display screen. When the included angle β is 90 degrees, it indicates that the flexible display screen is not bent. Generally, a variation range of the included angle β is [60 degrees, 90 degrees]. That is to say, the flexible display screen cannot be bent without limit. Certainly, different flexible display screens may have different bendable degrees, and the embodiment is not limited thereto.

Certainly, the bending degree of the flexible display screen may also be determined in other manners. For example, a tension sensor may be arranged in the middle of the flexible display screen. By detecting a tension degree of the middle of the flexible display screen, the bending degree of the flexible display screen may be determined. When the bending degree is larger, the tension degree of the middle of the flexible display screen is larger. Whereas, when the bending degree is smaller, the tension degree of the middle of the flexible display screen is smaller. A correspondence relationship between the tension degrees and the bending degrees is set in advance. After the tension degree of the middle of the flexible display screen is determined, a corresponding bending degree may be determined according to the correspondence relationship between tension degrees and bending degrees.

Step 102, a deformation value of the user interface is determined according to the bending degree and a preset correspondence relationship. The preset relationship is a relationship between the bending degrees of the flexible display screen and the deformation values of the user interface.

In the preset correspondence relationship, a large bending degree corresponds to a small deformation value of the user interface, and a small bending degree corresponds to a large deformation value of the user interface. That is to say, when the bending degree of the flexible display screen is larger, the deformation degree of the user interface is smaller, and when the bending degree of the flexible display screen is smaller, the deformation degree of the user interface is larger. When the bending degree of the flexible display screen is larger, the deformation degree of the user interface is enabled to be smaller, and when the bending degree of the flexible display screen is smaller, the deformation degree of the user interface is enabled to be larger. Thus, not only a good visual effect can be provided, but also various display manners can be provided, thereby improving user experience.

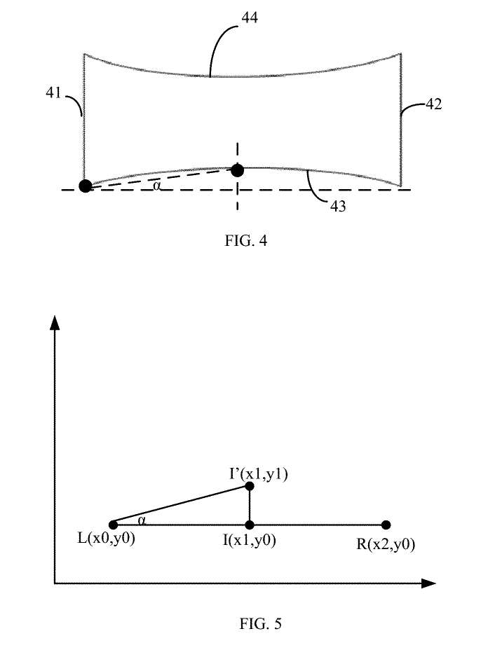

Take the user interface illustrated in FIG. 4 as an example, the user interface is symmetrical with respect to a longitudinal symmetrical line (a dotted line 25 illustrated in FIG. 2) of the flexible display screen. The user interface may include a left side 41, a right side 42, a lower side 43, and an upper side 44. The left side 41 is parallel to the right side 42, and a bending degree of the upper side 44 is the same as that of the lower side 43. The deformation value is an included angle α defined between a connection line and a horizontal line, and the connection line is a line connecting an end of a projection of the user interface on a horizontal plane in a vertical direction and a center of the user interface in a horizontal direction. Generally, a variation range of the included angle α is [0 degree, 30 degrees]. Certainly, the variation range of the included angle α can be adjusted according to a bendable range of the flexible display screen. When the included angle α is 0 degree, it indicates that the user interface does not need to be deformed, that is, the bending degrees of the upper side and the lower side are both 0 (the upper side and the lower side are straight lines).

Step 103, the user interface is adjusted according to the deformation value.

In an implementation, the display apparatus stores multiple different images of the user interface in advance. Different images of the user interface have different deformation values. Adjusting the user interface according to the deformation value may include the follows. From the multiple images of the user interface stored in advance, one image having the deformation value is selected.

In another implementation, adjusting the user interface according to the deformation value may include the follows. According to the deformation value and a manner of vector drawing, the user interface is adjusted. When the display apparatus displays a user interface, the display apparatus needs to set a display size and display position of the user interface. Specifically, as illustrated in FIG. 5, the display apparatus establishes a Cartesian coordinate system with a lower left corner of the flexible display screen without being bent as an origin, with the left side as a vertical axis, and with the lower side as a horizontal axis, and then sets positions of a lower left corner, an upper left corner, an upper right corner, and a lower right corner of the user interface in the Cartesian coordinate system. If the lower left corner is displayed on a position of L (x0, y0), and the lower right corner is displayed on a position of R (x2, y0), a position of a center of the lower side 43 of the user interface without being bent can be obtained, and it is assumed that the position of the center of the lower side 43 is a position of I (x1, y0). When the user interface needs to be deformed, the lower side 43 and the upper side 44 are bent. It is assumed that after being bent the position of the center I of the lower side 43 is changed to be I′ (x1, y1), where y1−y0=(x1−x0)×tan α. After y1 is determined, a system function of drawline (x0, y0; x1, y1) is called to draw a curve, that is, draw the lower side 43 after being bent. Since the bending degree of the lower side 43 is the same as that of the upper side 44, according to the drawing of the lower side 43, the upper side 44 after being bent can be drawn. When the included angle α is zero, it indicates that the user interface does not need to be deformed, and the system function of drawline (x0, y0; x1, y1) can be directly called to conduct a vector drawing to cause the lower side 43 and the upper side 44 of the user interface to be straight lines.

Step 104, the adjusted user interface is displayed on the flexible display screen.

In the implementation of the present disclosure, the shape of the user interface is changed according to the bending degree of the flexible display screen, thus the display effect of the user interface displayed on the flexible display screen is improved, and user experience is improved.

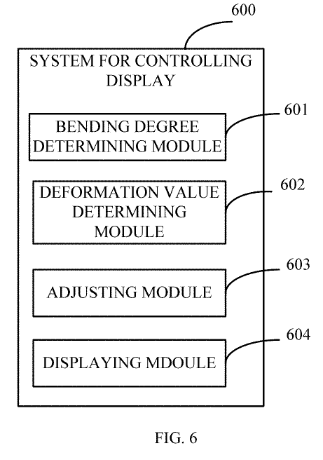

Referring to FIG. 6, FIG. 6 is a schematic structural diagram illustrating a system for controlling display according to an embodiment of the present disclosure. The system 600 for controlling display is applied in a display apparatus having a flexible display screen. The display apparatus may be an integrated display apparatus, and also may be a separate display apparatus, that is, the flexible display screen is separately arranged. When the display apparatus is the integrated display apparatus, the whole display apparatus can be deformed. When the flexible display screen is separately arranged, the flexible display screen can be deformed separately. The display apparatus may be a display apparatus having an image or text display function such as a smart phone, a tablet computer, a head-mounted display, a television, and the like. The system 600 for controlling display may include a bending degree determining module 601, a deformation value determining module 602, an adjusting module 603, and a displaying module 604.

The bending degree determining module 601 may be configured to determine a bending degree of the flexible display screen when the display apparatus displays a user interface on the flexible display screen.

As illustrated in FIG. 2, distance sensors 21, 22, and 23 are arranged on a left side, a middle, and a right side of the flexible display screen 20, respectively. The distance sensors 21, 22, and 23 may be laser sensors, ultrasonic sensors, and the like. When the flexible display screen 20 is not bent, the distance sensors 21, 22, and 23 are collinear in horizontal line. A distance between the distance sensor 22 and the distance sensor 21 is equal to that between the distance sensor 22 and the distance sensor 23, and both of which are b0.Referring to FIG. 3, FIG. 3 is a top view illustrating the flexible display screen 20 when the left side and the right side of the flexible display screen 20 are bent inwardly along the middle of the flexible display screen 20. As illustrated in FIG. 3, the distance between the distance sensor 22 and the distance sensor 21 and the distance between the distance sensor 22 and the distance sensor 23 are changed to b1, the distance sensors 21, 22, and 23 are not in line, and the distance sensors 21 and 23 are in line. The distance between the distance sensor 21 and the distance sensor 23 is c1. According to the distance b1 and c1, an included angle β between a central line passing through the distance sensor 22 and a connection line connecting the distance sensors 21 and 22 can be determined. The included angle β is defined as a bending degree of the flexible display screen. When the included angle β is 90 degrees, it indicates that the flexible display screen is not bent. Generally, a variation range of the included angle β is [60 degrees, 90 degrees]. That is to say, the flexible display screen cannot be bent without limit. Certainly, different flexible display screens may have different bendable degrees, and the embodiment is not limited thereto.

Certainly, the bending degree of the flexible display screen may also be determined in other manners. For example, a tension sensor may be arranged in the middle of the flexible display screen. By detecting a tension degree of the middle of the flexible display screen, the bending degree of the flexible display screen may be determined. When the bending degree is larger, the tension degree of the middle of the flexible display screen is larger. Whereas, when the bending degree is smaller, the tension degree of the middle of the flexible display screen is smaller. A correspondence relationship between the tension degrees and the bending degrees is set in advance. After the tension degree of the middle of the flexible display screen is determined, a corresponding bending degree may be determined according to the correspondence relationship between tension degrees and bending degrees.

The deformation value determining module 602 may be configured to determine a deformation value of the user interface according to the bending degree and a preset correspondence relationship. The preset correspondence relationship is a correspondence relationship between the bending degrees of the flexible display screen and the deformation values of the user interface.

In the preset correspondence relationship, a large bending degree corresponds to a small deformation value of the user interface, and a small bending degree corresponds to a large deformation value of the user interface. That is to say, when the bending degree of the flexible display screen is larger, the deformation degree of the user interface is smaller, and when the bending degree of the flexible display screen is smaller, the deformation degree of the user interface is larger. When the bending degree of the flexible display screen is larger, the deformation degree of the user interface is enabled to be smaller, and when the bending degree of the flexible display screen is smaller, the deformation degree of the user interface is enabled to be larger. Thus, not only a good visual effect can be provided, but also various display manners can be provided, thereby improving user experience.

Take the user interface illustrated in FIG. 4 as an example, the user interface is symmetrical with respect to a longitudinal symmetrical line (a dotted line 25 illustrated in FIG. 2) of the flexible display screen. The user interface may include a left side 41, a right side 42, a lower side 43, and an upper side 44. The left side 41 is parallel to the right side 42, and a bending degree of the upper side 44 is the same as that of the lower side 43. The deformation value is an included angle α defined between a connection line and a horizontal line, and the connection line is a line connecting an end of a projection of the user interface on a horizontal plane in a vertical direction and a center of the user interface in a horizontal direction. Generally, a variation range of the included angle α is [0 degree, 30 degrees]. Certainly, the variation range of the included angle α can be adjusted according to a bendable range of the flexible display screen. When the included angle α is 0 degree, it indicates that the user interface does not need to be deformed, that is, the bending degrees of the upper side and the lower side are both 0 (the upper side and the lower side are straight lines).

The adjusting module 603 may be configured to adjust the user interface according to the deformation value.

In an implementation, the display apparatus stores multiple different images of the user interface in advance. Different images of the user interface have different deformation values. The adjusting module 603 adjusting the user interface according to the deformation value may include the follows. The adjusting module 603 selects, from the multiple images of the user interface stored in advance, one image having the deformation value.

In another implementation, the adjusting module 603 adjusting the user interface according to the deformation value may include the follows. The adjusting module 603 adjusts the user interface according to the deformation value and a manner of vector drawing. When the display apparatus displays a user interface, the display apparatus needs to set a display size and display position of the user interface. Specifically, as illustrated in FIG. 5, the display apparatus establishes a Cartesian coordinate system with a lower left corner of the flexible display screen without being bent as an origin, with the left side as a vertical axis, and with the lower side as a horizontal axis, and then sets positions of a lower left corner, an upper left corner, an upper right corner, and a lower right corner of the user interface in the Cartesian coordinate system. If the lower left corner is displayed on a position of L (x0, y0), and the lower right corner is displayed on a position of R (x2, y0), a position of a center of the lower side 43 of the user interface without being bent can be determined, and it is assumed that the position of the center of the lower side 43 is a position of I (x1, y0). When the user interface needs to be deformed, the lower side 43 and the upper side 44 are bent. It is assumed that after being bent the position of the center I of the lower side 43 is changed to be I′ (x1, y1), where y1−y0=(x1−x0)×tan α. After y1 is determined, a system function of drawline (x0, y0; x1, y1) is called to draw a curve, that is, draw the lower side 43 after being bent. Since the bending degree of the lower side 43 is the same as that of the upper side 44, according to the drawing of the lower side 43, the upper side 44 after being bent can be drawn. When the included angle α is zero, it indicates that the user interface does not need to be deformed, and the system function of drawline (x0, y0; x1, y1) can be directly called to conduct a vector drawing to cause the lower side 43 and the upper side 44 of the user interface to be straight lines.

The displaying module 604 may be configured to display the adjusted user interface.

In the implementation of the present disclosure, the shape of the user interface is changed according to the bending degree of the flexible display screen, thus the display effect of the user interface displayed on the flexible display screen is improved, and user experience is improved.

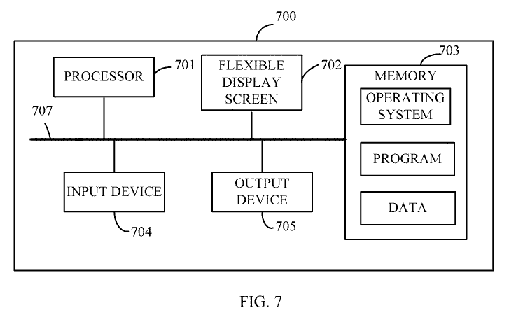

Referring to FIG. 7, in an implementation of the present disclosure, a display apparatus 700 can be used to execute the method for controlling display provided in the embodiments of the present disclosure. The display apparatus 700 may include a flexible display screen 702. The display apparatus 700 may be an integrated display apparatus, and also may be a separate display apparatus, that is, the flexible display screen 702 is separately arranged. When the display apparatus 700 is the integrated display apparatus, the whole display apparatus 700 can be deformed. When the flexible display screen 702 is separately arranged, the flexible display screen 702 can be deformed individually. The display apparatus 700 may be a display apparatus having an image or text display function such as a smart phone, a tablet computer, a head-mounted display, a television, and the like. The display apparatus 700 may include at least one processor 701, the flexible display screen 702, a memory 703, at least one input device 704, at least one output device 705, and so on. These components communicate with each other via one or more buses 707. A person of ordinary skill in the art can understand that the structure of the display apparatus illustrated in FIG. 7 does not limit the present disclosure. The display apparatus may be a bus structure or a star structure. The display apparatus may include more or fewer components than illustrated, or may combine certain components, or may include different components.

In the embodiment of the present disclosure, the processor 701 is the control center of the display apparatus 700, it connects various parts of the whole display apparatus 700 through various interfaces and lines, runs or executes software programs and/or units stored in the memory 703 and invokes data stored in the memory 703 to perform various functions of the display apparatus 700 and process data. The processor 701 may be formed by one or more integrated circuits (ICs). For example, the processor 701 may be formed by a single encapsulated IC, and also may be formed by connecting multiple encapsulated ICs having the same function or having different functions. For example, the processor 701 may just include a central processing unit (CPU), and also may be a combination of the CPU, a digital signal processor (DSP), a graphic processing unit (GPU), and various control chips. In the embodiment of the present disclosure, the CPU may include a signal core, or may include multiple cores.

In the embodiment of the present disclosure, the input device 704 may include a standard touch screen, a keyboard, and so on, and also may include a wired interface, a wireless interface, and so on, to realize interaction between a user and the display apparatus 700.

In the embodiment of the present disclosure, the output device 705 may be a display screen, a loudspeaker, and may include a wired interface, a wireless interface, and so on.

In the embodiment of the present disclosure, the memory 703 may include at least one of the follows: a random access memory, a nonvolatile memory, and an external memory. The memory 703 may store program codes. The processor 701 performs the above method for controlling display by invoking the program codes stored in the memory 703. The memory 703 mainly includes a program storage area and a data storage area. The program storage area may store an operating system, applications for at least one function, and so on. The data storage area may store data created according to usage of the display apparatus and so on. In the embodiment of the present disclosure, the operating system may be the Android system, the iOS system, the Windows operating system, or other.

The above disclosures illustrate preferable embodiments of the present disclosure. It should be pointed out that a person of ordinary skill in the art can make several changes and polish without departing from the principle of the present disclosure, and these changes and polish shall be deemed as the scope of protection of the present disclosure.

1. A method for controlling display applied in a display apparatus, the display apparatus comprising a flexible display screen, the method for controlling display comprising:
determining a bending degree of the flexible display screen when a user interface is displayed on the flexible display screen;
determining a deformation value of the user interface according to the bending degree of the flexible display screen and a preset correspondence relationship, wherein the preset correspondence relationship is a correspondence relationship between the bending degrees of the flexible display screen and the deformation values of the user interface;
adjusting the user interface according to the determined deformation value; and
displaying the adjusted user interface on the flexible display screen.

2. The method for controlling display of claim 1, wherein the adjusting the user interface according to the determined deformation value comprises:
selecting, from a plurality of pre-stored images of the user interface, one image having the deformation value;
the displaying the adjusted user interface on the flexible display screen comprises:
displaying the selected image having the deformation value on the flexible display screen.

3. The method for controlling display of claim 1, wherein the adjusting the user interface according to the deformation value comprises:
adjusting the user interface according to the determined deformation value and a manner of vector drawing.

4. The method for controlling display of claim 1, wherein the deformation value is an included angle defined between a connection line and a horizontal line, the connection line is a line connecting an end of a projection of the user interface on a horizontal plane in a vertical direction and a center of the user interface in a horizontal direction.

5. The method for controlling display of claim 1, wherein in the preset correspondence relationship, a large bending degree corresponds to a small deformation value, and a small bending degree corresponds to a large deformation value.

6-10. (canceled)

11. A display apparatus comprising:
a flexible display screen;
at least one processor; and
a computer readable memory, coupled to the at least one processor and storing at least one computer executable instruction therein, which when executed by the at least one processor, causes the at least one processor to:
determine a bending degree of the flexible display screen when a user interface is displayed on the flexible display screen;
determine a deformation value of the user interface according to the bending degree of the flexible display screen and a preset correspondence relationship, wherein the preset correspondence relationship is a correspondence relationship between the bending degrees of the flexible display screen and the deformation values of the user interface;
adjust the user interface according to the determined deformation value; and
display the adjusted user interface on the flexible display screen.

12. The display apparatus of claim 11, wherein
the at least one computer executable instruction causing the at least one processor to adjust the user interface according to the determined deformation value causes the at least one processor to: select, from a plurality of pre-stored images of the user interface, one image having the deformation value;
the at least one computer executable instruction causing the at least one processor to display the adjusted user interface on the flexible display screen causes the at least one processor to: display the selected image having the deformation value on the flexible display screen.

13. The display apparatus of claim 11, wherein
the at least one computer executable instruction causing the at least one processor to adjust the user interface according to the deformation value causes the at least one processor to: adjust the user interface according to the deformation value and a manner of vector drawing.

14. The display apparatus of claim 10, wherein the deformation value is an included angle defined between a connection line and a horizontal line, the connection line is a line connecting an end of a projection of the user interface on a horizontal plane in a vertical direction and a center of the user interface in a horizontal direction.

15. The display apparatus of claim 10, wherein in the preset correspondence relationship, a large bending degree corresponds to a small deformation value, and a small bending degree corresponds to a large deformation value.

16. A non-transitory computer-readable storage medium storing at least one computer executable instruction which, when executed by at least one processor, causes the at least one processor to carry out actions, comprising:
determining a bending degree of the flexible display screen when a user interface is displayed on the flexible display screen;
determining a deformation value of the user interface according to the bending degree of the flexible display screen and a preset correspondence relationship, wherein the preset correspondence relationship is a correspondence relationship between the bending degrees of the flexible display screen and the deformation values of the user interface;
adjusting the user interface according to the determined deformation value; and
displaying the adjusted user interface on the flexible display screen.

17. The non-transitory computer-readable storage medium of claim 16, wherein
the at least one computer executable instruction executed by the at least one processor to carry out the action of adjusting the user interface according to the determined deformation value is executed by the at least one processor to carry out an action, comprising: selecting, from a plurality of pre-stored images of the user interface, one image having the deformation value;
the at least one computer executable instruction executed by the at least one processor to carry out the action of displaying the adjusted user interface on the flexible display screen is executed by the at least one processor to carry out an action, comprising: displaying the selected image having the deformation value on the flexible display screen.

18. The non-transitory computer-readable storage medium of claim 16, wherein
the at least one computer executable instruction executed by the at least one processor to carry out the action of adjusting the user interface according to the deformation value is executed by the at least one processor to carry out an action, comprising: adjusting the user interface according to the determined deformation value and a manner of vector drawing.

19. The non-transitory computer-readable storage medium of claim 15, wherein the deformation value is an included angle defined between a connection line and a horizontal line, the connection line is a line connecting an end of a projection of the user interface on a horizontal plane in a vertical direction and a center of the user interface in a horizontal direction.

20. The non-transitory computer-readable storage medium of claim 15, wherein in the preset correspondence relationship, a large bending degree corresponds to a small deformation value, and a small bending degree corresponds to a large deformation value.
